(19) United States
(12) Patent Application Publication
(10) Pub. No.: US 2012/0056426 A1
(43) Pub. Date: Mar. 8, 2012

(54) CONTROL SYSTEM AND METHOD FOR A WIND TURBINE

(76) Inventors: Gijsbertus Arnoldus Maria Van Kuik, JL Houten (NL); Robert Owen Bowyer, London (GB); Kelvin Beverley Hales, Surrey (GB)

(21) Appl. No.: 13/147,576

(22) PCT Filed: Feb. 2, 2010
(86) PCT No.: PCT/GB2010/000178

§ 371 Date: Nov. 16, 2011

(30) Foreign Application Priority Data
Feb. 2, 2009 (NL) 2002476

(51) Int. Cl. H02P 9/04

(52) U.S. Cl. 290/44

(57) ABSTRACT

A wind turbine has a rotor with a hub that houses a remote sensing device such as a Lidar for each blade. Each Lidar has one or more look directions that extend generally radially along the respective blade in front of the blade. The Lidar has multiple range gates and wind parameters sensed at each range may be used to control surfaces on the blade such as a trailing edge flap.

This invention relates to a control system and method for a wind turbine which has a remote sensor mounted for rotation with the wind turbine rotor. The invention also relates to a wind turbine having such a control system.

U.S. Pat. No. 7,281,891 discloses a remote sensor in the form of a Lidar mounted in the hub of the turbine and having a look direction inclined to the axis of rotation of the hub such that as the hub rotates the Lidar scans an area in front of the turbine. The look directions are inclined at an angle within the range of 5°-20° of the axis of rotation, preferably in the range of 10°-20°. The wind speed as measured with the Lidar is used as a measure, depending on which a controller controls the pitch of the rotor blades of the wind turbine. The pitch of the blades is varied depending on the measured wind speed so as to vary the force experienced by the blades to maximise efficient power extraction but also to protect the blades by limiting the forces acting on the blades of the wind turbine.

The wind turbine disclosed U.S. Pat. No. 7,281,891 alters the pitch of the respective blades of the turbine individually, depending on the measured wind speed, whereby due account can be taken of different wind conditions when a blade is upwardly directed as opposed to the blade being directed downwards. However, inaccuracies remain which reduce efficiency attainable as well as the maximum wind forces that the wind turbine can endure without damage.

The invention addresses and ameliorates the above mentioned disadvantages. The invention is defined by the independent claims to which reference should be made.

In a first aspect of the invention a remote sensing device is mounted for rotation with the rotor so as to have a look direction that is substantially parallel to and adjacent one or more of the blades. This arrangement enables very accurate sensing and measurement of wind parameters including forces immediately in front of the blades which may be used to control parameters of the wind turbine thus improving the accuracy of the system.

In one preferred embodiment, the blades of the turbine are each provided with one or more control surfaces. These control surfaces are controlled depending on a wind parameter, for example, the wind speed as sensed by the sensing device. Such a control surface may be a trailing edge flap or other devices such as are described in “State of the Art and Prospectives of Smart Rotor Control for Wind Turbines” by T. K Barlas and G. A. M. van Kuik, published in the Science of Making Torque from Wind, Journal of Physics: Conference Series 75 (2007) 012080 pages 1-20. This document is herein incorporated by reference.

Each blade has a leading edge and a trailing edge defining a chord length there between. Preferably the sensing device is arranged to measure the wind speed at a distance upstream of the blade which is in the range of 0.5-3 chord lengths, preferably one chord length. This provides sufficient time to control the wind turbine parameter that is responsive to the sensed wind parameter. It is also sufficiently distant from the blade to avoid the parameter sensed being affected by the blade.

Preferably the sensing device is arranged to measure a wind profile in front of the blade. This allows an even more accurate control of control surfaces, particularly when the blades of the turbine each have individually controllable control surfaces that are distributed along the blades. In that embodiment it is desirable that control surfaces are selectively and individually controlled. In view of the use of multiple control surfaces it is preferred that the remote sensing device, which may be a Lidar, has multiple range gates.

Preferably, the remote sensing device is a Doppler anemometer and preferably a Lidar device. It is still further preferred that the remote sensing device is a pulsed Lidar.

The remote sensing device may be mounted in the hub for rotation with the hub or may be mounted on a blade. If mounted on a blade it is preferred that the device is close to the hub for ease of control with a look direction extending towards the blade tip. However, the device could be mounted rear of the tip with a look direction extending towards the hub.

It is preferred that the look direction is in front of the blade extending radially along the blade.

Preferably the look direction of the sensing device is adjustable whereby the position of the look direction with respect to the blade can be maintained as the blade pitches.

The sensed wind parameter may comprise one or more of wind speed, wind direction, vertical or horizontal shear and turbulence. To enable more accurate control, a separate sensing device may be provided for each blade. The or each sensing device may have a plurality of look directions with further look directions being offset with respect to a first look direction, for example by an angle of up to 30°. This arrangement has the advantage that a two or three dimensional picture of the wind may be built up at the point of measurement to enable more complex wind parameters such as turbulence and shear to be determined.

The sensing device may have a further look direction offset from the axis of rotation of the hub and extending generally in front of the turbine. The combination of sensing in generally axial and radial directions is advantageous in establishing an accurate determination of wind conditions.

A further aspect of the invention resides in a wind turbine having at least one Lidar means for determining wind speed, wherein said at least one Lidar means is mounted in a hub bearing blades of the turbine, such that as the hub rotates the at least one Lidar means scans the area in front of the turbine, characterized in that the at least one Lidar means is mounted in the hub so as to have a look direction that radially extends away from the hub, and that is substantially parallel to and next to one of the blades extending radially from the hub.

Preferably, in this aspect of the invention the blades of the turbine are each provided with a controllable aerodynamic device or devices, said device of devices being controlled depending on the wind speed as measured by the at least one Lidar means. Preferably, the blades of the turbine each have individually controllable aerodynamic devices that are distributed in the blades' radial direction from the hub, which devices are selectively controlled depending and in correspondence with the wind-profile as measured with the at least one Lidar means. Preferably, each blade of the turbine has an associated Lidar means that has a look direction parallel and next to such blade and each blade has a controllable aerodynamic device or devices which is or are controlled depending only on wind data as measured by the Lidar means that is associated with such blade.

Embodiments of the invention will now be described, by way of example only, and with reference to the accompanying drawings, in which:

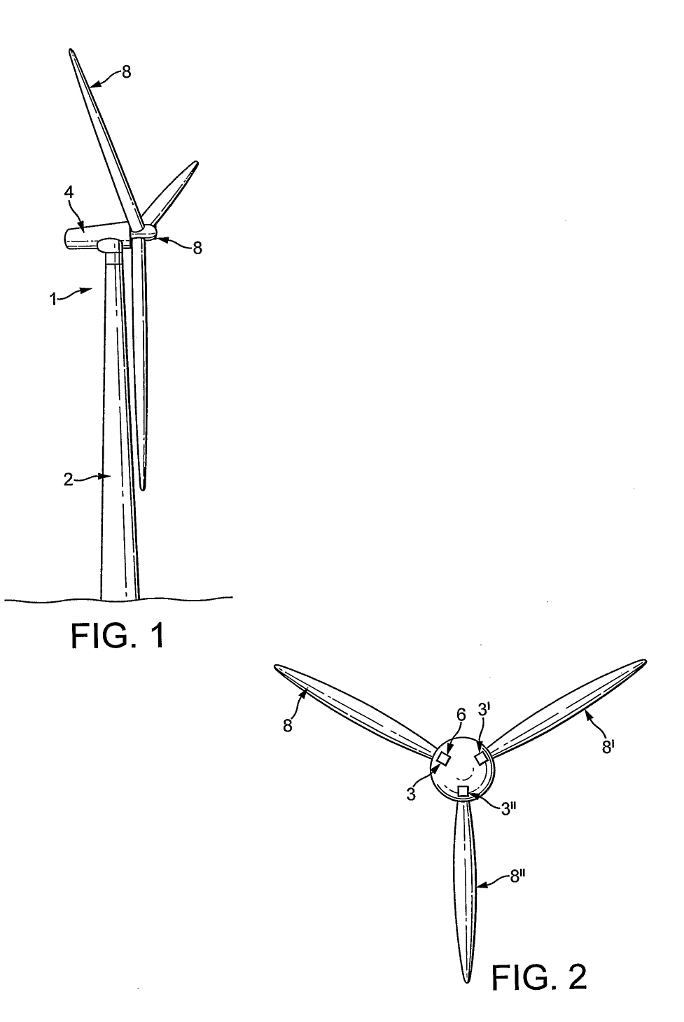

FIG. 1 shows a schematic of a wind turbine embodying the invention and having a hub mounted Lidar; and

FIG. 2 shows a front view of a rotor hub bearing the turbine blades and having three Lidar in accordance with a preferred embodiment of the wind turbine of the invention.

Wherever in the figures the same reference numerals are applied these relate to the same parts.

FIG. 1 shows a wind turbine 1 which has a tower 2 bearing a nacelle which can move about the tower axis 4. Connected to the nacelle 4 is a rotatable hub 6 which having three rotor blades 8. The rotor may have a different number of blades.

As is common in the art the nacelle 4 is rotatable in a generally horizontal plane, so that the hub axis 6 and the blades 8 are aligned with the wind direction.

As shown in FIG. 2 the hub 6 that bears the blades 8, 8′, 8″ houses three remote sensing devices such as Lidar means 3, 3′ 3″ that are used to scan an area in front the turbine 1. Each of the Lidar means 3, 3′, 3″ is mounted to have a look direction that radially extends away from the hub 6 and that is substantially parallel and adjacent the respective blade 8, 8′, 8″. A remote sensor is one which senses conditions of a position distant from the sensor. In the case of Lidar, this is through detection of scattered laser light.

In FIG. 2 Lidar means 3 is associated and corresponds to blade 8; Lidar means 3′ is associated with blade 8′; and Lidar means 3″ is associated with blade 8″. Although the embodiment shown in FIG. 2 is a preferred embodiment it is also possible that only one of the Lidar means 3, 3′ or 3″ is used and that, that single Lidar means is used to control the blades 8, 8′ and 8″ collectively. It will be clear, however, that preference is given to individual control of the blades 8, 8′ and 8″ depending on their associated Lidar means 3, 3′ and 3″ respectively.

In the embodiments described the sensing devices such as a Lidar device or devices are mounted in the hub with a look direction extending generally radially outwards towards the blade tip. Alternatively (not shown), the Lidar device may be mounted on one or more individual blades having a look direction extending generally along the blade towards the tip. In a further alternative the Lidar device could be mounted towards the blade tip with a look direction that extends back toward the hub. In the case of blade mounted Lidar it is preferred that the Lidar is attached to a support such as a pole that extends a few metres in front of the leading edge of the blade so that the look direction is a little in front of, and generally parallel, to the blade.

Although Lidar devices are the presently preferred remote sensing devices, other remote sensing devices such as Sodar or another Doppler anemometer could be used.

The Lidar devices may be any known Lidar device including continuous wave Lidar and pulsed Lidar. As is explained below, pulsed Lidar is presently preferred for applications where it is desired to measure wind parameters at several points along the blade.

The remote sensing device operates by emitting a beam in the look direction which detects conditions at a specific area close to the blade. In the case of Lidar, this measurement is based on the detection of radiation scattered either from particles in the air or by the air molecules themselves depending on the type of Lidar used.

The Lidar or other remote sensing device may measure a single wind parameter such as wind speed or wind direction or may measure multiple parameters such as any of wind speed, direction, shear and turbulence. Shear may be horizontal and/or vertical shear in the wind as it approaches the turbine or it may be some other shear parameter such as radial shear along the length of the blade or perpendicular shear with respect to the blade. Some parameters may be detected using a single beam, for example wind speed, but others require a two or three dimensional picture of the wind to be built up. In such cases the Lidar or other remote sensing devices may emit two or three beams one of which is generally parallel to blade axis and the others of which are inclined to the axis typically by up to 30°. Where the Lidar is hub mounted, a separate Lidar may be provided for each blade or a common Lidar device may be used that has multiple look directions.

Such a Lidar has one or more look directions in the direction of each blade and may use a single laser device and a device for splitting the output into multiple beams. This may be, for example, a conventional beam splitting device or a multiplexer such as a time division multiplexer with individual input/output optics for each beam such as is taught by EP 1,597,592. Other beam division arrangements are possible.

As a further alternative, the Lidar may be combined with a forward looking Lidar such as is known from U.S. Pat. No. 7,281,891 referred to above. Such a device may be separate from, or combined with, the Lidar described. For example, the hub mounted multiple beam Lidar described may have one or more additional look directions which are offset from the rotor axis by a small amount, for example, up to 30°. Such an arrangement is advantageous as the generally forward looking beams are well suited to detect wind speed whereas the generally radially extending look directions are well suited for determining wind direction. Signals from both may be combined by a system controller to establish an accurate picture of the wind and so enable more precise control of wind turbine parameters such as a pitch angle.

In one preferred embodiment, the blades 8, 8′, 8″ of the turbine 1 are each provided with one or more control surfaces such as a trailing edge flap. These surfaces are controlled by a controller (not shown) that is responsive to the sensing device such as the Lidar means 3, 3′, 3″ such that the actuation of the control surfaces depends on the one or more wind parameters as measured by the sensing devices 3, 3′, 3″. The manner of implementation of the control devices as a part of the blades 8, 8′, 8″ is known to those skilled in the art. Reference is made to “State of the Art and Prospectives of Smart Rotor Control for Wind Turbines” by T. K. Barlas ad G. A. M. van Kuik, as published in the Science of Making Torque from Wind, Journal of Physics: Conference Series 75 (2007) 012080, pages 1-20.

As is known each blade 8, 8′, 8″ has a leading edge and a trailing edge and the distance between is defined as the chord length. In a preferred aspect of the invention, the Lidar means or other sensing device 3, 3′, 3″ is arranged to measure the wind speed at a distance upstream of the blade 8, 8′, 8″ which is in the range of 0.5-3 chord lengths, preferably one chord length. Where the parameter sensed is used to control the control surface it is important that the measurement is made close to the blade, but not so close that the blade interferes with the measurement, for example, due to three-dimensional effects. Thus, it is preferred that the measurement is made a minimum of 0.5 chord-lengths from the trailing edge. This distance is also chosen to give the system controller sufficient time to move the control surface to the desired position.

The point of measurement is a distance in front of the leading edge of the blade dependent on the tip speed ratio of the blade and an orthogonal distance below the centre of the blade that is determined by a fixed offset angle for example in the range 5° to 20° and preferably 15°. The look directions of the one or more beams of each Lidar may be adjustable so that the beam may follow pitch angle adjustments and maintain a desired position with respect to the position of the leading edge of the blade.

In many instances a blade will carry multiple flaps or other control surfaces. It is preferred that each flap is controlled individually. This requires measurement of the wind parameters for each control surface. Thus, it is preferred that the Lidar or other remote sensing device is a multiple range gate sensing device. This requirement makes the use of pulsed Lidar preferable to continuous wave Lidar. Pulsed Lidar with multiple range gates are themselves well known.

It should be noted that the point at which the wind parameters are measured for a given control surface may not be directly in front of the leading edge opposite that control surface. The shape of the blade and three dimensional effects in the airflow over the blade may require the measurement point for a given control surface to be radially offset with respect to that control surface to give the best results.

It will be appreciated that the wind conditions may not be constant along the blade. As the Lidar 3, 3′, 3″ measure directly in front of at least one of the blades 8, 8′, 8″, it is possible to measure a wind profile upstream of such blade 8, 8′, 8″ and so determine how measured parameters change along the blade where multiple control surfaces are distributed along the blades. These surfaces may be selectively controlled depending and in correspondence with the wind profile as measured with the at least one Lidar means 3, 3′, 3″.

As FIG. 2 shows, in a preferred embodiment the wind turbine is arranged such that each blade 8, 8′, 8″ of the turbine has an associated Lidar means 3, 3′, 3″ that has a look direction that extends radially away from the hub 6 and that is generally parallel and next to such blade 8, 8′, 8″. Each blade 8, 8′, 8″ preferably has one or more control surfaces which are controlled in response to wind data as measured by the Lidar means 3, 3′, 3″ that is associated with blade 8, 8′, 8″ or to which the control surface is mounted or attached.

In the embodiment described, signals from the Lidar are used to control the position of one or more trailing edge flaps or other control surfaces on each of the rotor blades. The Lidar signals may be used for other control parameters either in addition to or as an alternative to control surface control. For example the Lidar signals may provide an input to a turbine controller which controls one or more of blade pitch (either collective or individual), yaw angle and generator torque or current reference.

Many modifications may be made to the embodiments described without departing from the scope of the invention which is defined only by the following claims.

1. A control system for a wind turbine, the wind turbine having a rotor carrying blades, comprising a remote sensing device mounted for rotation with the rotor to sense at least one wind parameter in a look direction substantially parallel to and adjacent a bade, and a controller for generating a control signal to vary a parameter of the wind turbine in response to the sensed wind parameter.

2. A control system according to claim 1, wherein the remote sensing device comprises at least one of a Doppler anemometer and a Lidar.

3. (canceled)

4. A control system according to claim 1, wherein the remote sensing device is mounted in the rotor hub of the wind turbine.

5. A control system according to claim 1, wherein the remote sensing device is mounted on the blade.

6. A control system according to claim 1, wherein the look direction is in front of the blade and extends radially along the blade.

7. A control system according to claim 6, wherein the remote sensing device measures the wind parameter at a position between 0.5 and 3 chord lengths of the blade upstream of the blade.

8. A control system according claim 1, wherein the wind parameter comprises at least one of wind speed and wind direction.

9. (canceled)

10. A control system according to claim 1, wherein the wind parameter comprises shear and/or turbulence.

11. A control system according to claim 1, wherein the look direction of the sensing device is adjustable whereby the position of the look direction with respect to the blade is maintained as the blade pitches.

12. A control system according to claim 1, comprising a remote sensing device for sensing each blade of the rotor.

13. A control system according to claim 1, wherein the remote sensing device comprises a further look direction at an offset angle to said look direction.

14. A control system according to claim 13, wherein the offset angle is 30° or less.

15. A control system according to claim 1, wherein the remote sensing device further has a look direction offset from the axis of rotation of the rotor and extending generally in front of the wind turbine.

16. A control system according to claim 1, wherein the blade has a control surface and the control signal generated by the controller controls the position of the control surface.

17. A control system according to claim 1, wherein the control surface is a trailing edge flap.

18. A control system according to claim 16, wherein the blade has a plurality of control surfaces and the remote sensing device senses the wind parameter at a corresponding plurality of locations to generate a control signal for each control surface.

19. A control system according to claim 1, wherein the Lidar is a pulsed Lidar.

20. A wind turbine including a control system according to claim 1.

21. A method of controlling a wind turbine, the wind turbine having a rotor carrying blades, comprising:
sensing with a remote sensing device mounted for rotation with the rotor, at least one wind parameter in a look direction substantially parallel to and adjacent a blade, and
controlling a parameter of the wind turbine with a control signal generated in response to the sensed wind parameter.

22. A windturbine comprising at least one lidar means for determining windspeed, wherein said at least one lidar means is mounted in a hub bearing blades of the turbine, such that as the hub rotates the at least one lidar means scans the area in front of the turbine wherein the at least one lidar means is mounted in the hub so as to have a look direction that radially extends away from the hub, and that is substantially parallel to and next to one of the blades extending radially from the hub.

23. A windturbine according to claim 22, wherein the blades of the turbine are each provided with a controllable aerodynamic device or devices, said device of devices being controlled depending on the wind speed as measured by the at least one lidar means.

24. A windturbine according to claim 22, wherein the blades of the turbine each have individually controllable aerodynamic devices that are distributed in the blades radial direction from the hub, which devices are selectively controlled depending and in correspondence with the wind-profile as measured with the at least one lidar means.

25. A windturbine according to claim 22, wherein each blade of the turbine has an associated lidar means that has a look direction parallel and next to such blade and that each blade has a controllable aerodynamic device or devices which is or are controlled depending only on wind data as measured by the lidar means that is associated with such blade.
